(19) United States
(12) Patent Application Publication
(10) Pub. No.: US 2022/0239036 A1
(43) Pub. Date: Jul. 28, 2022

(54) Communication System Connector

(71) Applicant: Nokia Shanghai Bell Co., Ltd., Shanghai (CN)

(72) Inventors: Yin-shing CHONG, Middletown, CT (US); Kyle REUTENAUER, Wallingford, CT (US)

(21) Appl. No.: 17/611,414

(22) PCT Filed: May 24, 2019
(86) PCT No.: PCT/US2019/033881

§ 371 Date: Nov. 15, 2021

(51) Int. Cl. H01R 13/623; G02B 6/38; H01R 13/639; H01R 13/625; H01R 13/627

(52) U.S. Cl. CPC H01R 13/623; G02B 6/389; H01R 13/6272; H01R 13/639; H01R 13/625; G02B 6/3825

(57) ABSTRACT

In accordance with an example embodiment, an apparatus is disclosed. The apparatus includes an adapter, a coupler, and a sleeve. The coupler is configured to be connected to the adapter. The coupler includes a lever. The sleeve is connected to the coupler. The lever is configured to deflect when the coupler is rotated relative to the sleeve.

### BACKGROUND

### Technical Field

The example and non-limiting embodiments relate to a communication system connector and, more particularly, to a locking feature for a communication system connector.

### Brief Description of Prior Developments

Telecommunication networks require quality connections between cable segments, network equipment, devices, etc., in order to provide the efficiency and reliability demanded by the users of the networks. In harsh environments, conventional communication system connectors often become unintentionally disconnected due to vibration, impact, temperature changes, and exposure to other harsh conditions.

Accordingly, there is a need to provide improved communication system connectors having robust and reliable product configurations.

### SUMMARY

Various examples are set out in the claims.

According to one example, an apparatus is disclosed. The apparatus includes an adapter, a coupler, and a sleeve. The coupler is configured to be connected to the adapter. The coupler includes a lever. The sleeve is connected to the coupler. The lever is configured to deflect when the coupler is rotated relative to the sleeve.

According to another example, an apparatus is disclosed. The apparatus includes an adapter, a coupler, and a sleeve. The coupler is configured to be connected to the adapter. The sleeve is connected to the coupler. The sleeve includes a ramp feature. A portion of the coupler is configured to deflect when the portion of the coupler is rotated over the ramp feature.

According to another example, an apparatus is disclosed. The apparatus includes an adapter, a coupler, and a sleeve. The coupler is configured to be connected to the adapter. The sleeve is connected to the coupler. The apparatus further includes means for locking the coupler to the sleeve to prevent rotation of the coupler relative to the sleeve.

### BRIEF DESCRIPTION OF THE DRAWINGS

Some example embodiments will now be described with reference to the accompanying drawings:

FIG. 1 is a perspective view of communication system connector in which the exemplary embodiments may be practiced;

FIG. 2 is an exploded view of the communication system connector shown in FIG. 1;

FIG. 3 is another perspective view of the communication system connector shown in FIG. 1;

FIG. 4 is an enlarged view of a portion of FIG. 3;

FIG. 5 is an end view of the communication system connector shown in FIG. 1;

FIG. 6 is another end view of the communication system connector shown in FIG. 1; and

FIG. 7 is another end view of the communication system connector shown in FIG. 1.

### DETAILED DESCRIPTION

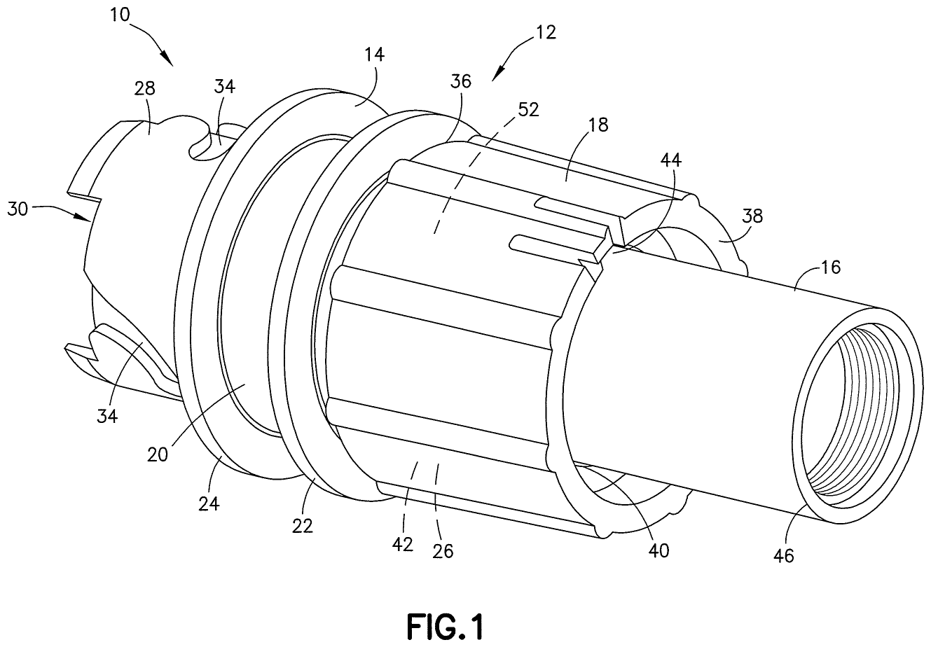

Referring to FIG. 1, there is shown a perspective view of a communication system connector 10 incorporating features of various example embodiments. Although various example embodiments will be described with reference to the drawings, it should be understood that various example embodiments can be embodied in many alternate forms of embodiments. In addition, any suitable size, shape or type of elements or materials could be used.

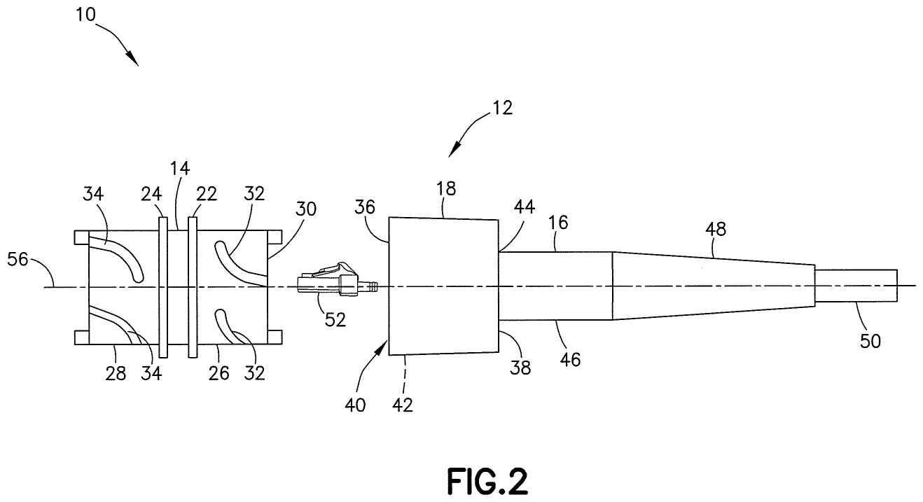

Referring now also to FIG. 2, the communication system connector 10 comprises a connector housing 12 having an adapter 14, a sleeve 16, and a coupler 18. The adapter 14 comprises a body section 20, a first flange section 22, a second flange section 24, a first receiving section 26, a second receiving section 28, and an opening extending through the body section 20. The first receiving section 26 comprises grooves 32. The second receiving section 28 comprises grooves 34.

The coupler 18 comprises a first end 36, an opposite second end 38, and an opening 40 extending therethrough. The coupler further comprises pin features 42 located on an inside diameter of the coupler proximate the first end. The pin features 42 are sized and shaped to be received by the grooves 32.

The sleeve 16 comprises a general tube shape and has a first end 44 and an opposite second end 46. The first end 44 is received by the coupler 18 and the second end 46 extends away from the second end 38 of the coupler 18. The second end 46 of the sleeve 16 is configured to connect to a cable fitting 48 and allows a cable 50 to extend therethrough.

The connector housing 12 is configured to house an LC connector 52 within the opening 30 of the adapter 14 when the coupler 18 is attached to the first receiving section 26 of the adapter 14. It should be noted that although various exemplary embodiments have been described in connection with the LC (Lucent Connector) connector 52, alternate embodiments may be provided with other suitable types of connectors.

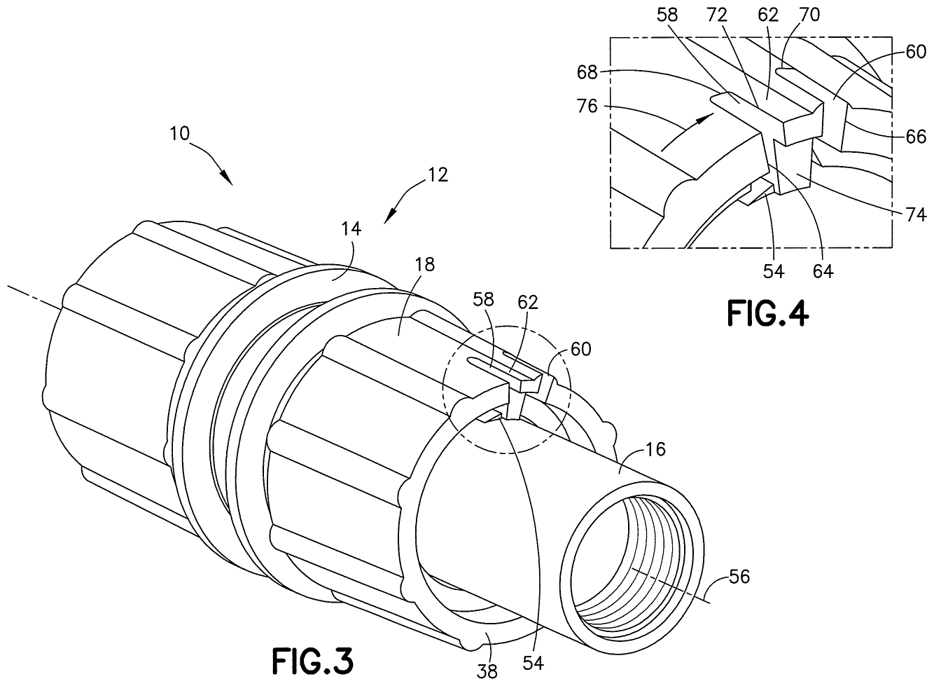

Referring now also to FIGS. 3 and 4, the first end 44 of the sleeve 16 further comprises a ramp feature 54 along an outer diameter of the sleeve 16. The ramp feature 54 is oriented such that that ramp feature 54 increases in ‘height’ (in a radial direction so as to increase in distance from a central axis 56 of the connector 10) in a direction substantially perpendicular to the central axis 56 of the connector 10.

The coupler 18 further comprises a first slotted hole 58 extending through a thickness of the coupler 18 (and having an open end 64 at the second end of the coupler 18) and a second slotted hole 60 extending through a thickness of the coupler 18 (and having an open end 66 at the second end 38 of the coupler 18). The first and second slotted holes 58, 60 form a lever 62 proximate the second end 38 of the coupler 18. The lever 62 extends from the wall section (proximate closed ends 68, 70 of the slotted holes 58, 60) of the coupler 18 in a general cantilever fashion. According to various exemplary embodiments, the lever 62 is integrally formed with the coupler 18 such that the lever 62 and the coupler 18 form a one-piece member.

The lever 62 comprises a deflection portion 72 and a ramp contact portion 74. The ramp contact portion extends (in a radial direction relative to the central axis 56) from the deflection portion 72 towards the sleeve 16.

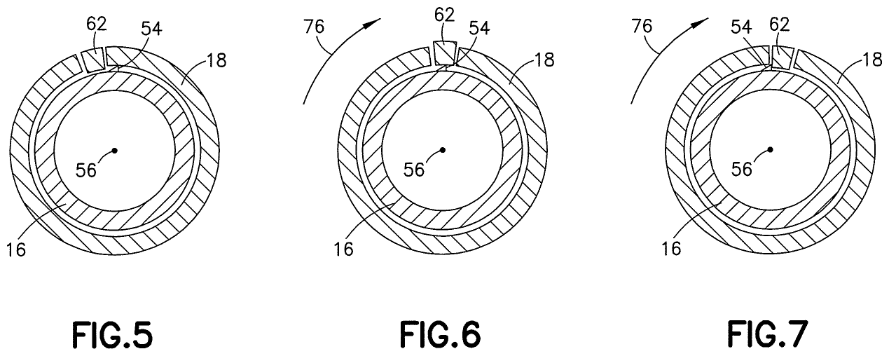

Referring now also to FIGS. 5-7, when the coupler 18 is assembled to the adapter 14, the lever deflection portion 72 deflects as the ramp contact portion 74 passes over the ramp feature 54 (and snaps in place over the ramp feature 54) when coupler is turned clockwise (see arrow 76). When the ramp contact portion 74 snaps in place over the ramp feature 54 (see FIGS. 3, 4, 7) this then prevents the coupler 18 from turning on its own. To then disconnect the coupler 18 from the adapter 14, the lever 62 may be lifted up slightly over height of ramp feature 54, which then allows the coupler 18 to be rotated in a counter-clockwise direction (i.e. direction opposite of 76).

It should be noted that although various exemplary embodiments have been described in connection with the coupler having only one lever (74) and the sleeve having only one corresponding ramp feature (54), other alternate embodiments may be provided where the coupler has more than one lever (74) [spaced along a circumference of the coupler] and the sleeve has a corresponding number of ramp features (54) [spaced along a circumference of the sleeve).

Technical effects of any one or more of the exemplary embodiments provide improvements when compared to other configurations. For example, one technical effect is providing an improved LC connector housing (at a reduced cost) that will mate with the conventional connectors (i.e. such that interfaces match those already deployed in the field). Another technical effect of the various exemplary embodiments is providing a connector with a locking feature which helps to prevent the connector from becoming detached by vibration, impact, or improper installation. Another technical effect of the various exemplary embodiments is provision for an anti-rotation feature by making use of a cantilever snap feature consisting of a lever and ramp.

It should be understood that components of the one or more various exemplary embodiments can be operationally coupled or connected and that any number or combination of intervening elements can exist (including no intervening elements). The connections can be direct or indirect and additionally there can merely be a functional relationship between components.

Below are provided further descriptions of various non-limiting, exemplary embodiments. The below-described exemplary embodiments may be practiced in conjunction with one or more other aspects or exemplary embodiments. That is, the one or more various exemplary embodiments, such as those described immediately below, may be implemented, practiced or utilized in any combination (e.g., any combination that is suitable, practicable and/or feasible) and are not limited only to those combinations described herein and/or included in the appended claims.

In one exemplary embodiment, an apparatus comprising: an adapter; a coupler configured to be connected to the adapter, wherein the coupler comprises a lever; and a sleeve connected to the coupler; wherein the lever is configured to deflect when the coupler is rotated relative to the sleeve.

An apparatus as above, wherein the sleeve comprises a ramp feature, and wherein lever is configured to deflect when the lever is rotated over the ramp feature.

An apparatus as above, wherein the lever extends from the coupler in a general cantilever fashion.

An apparatus as above, wherein the lever and the coupler comprise a one-piece member.

An apparatus as above, wherein the sleeve comprises a general tubular shape.

An apparatus as above, wherein the lever is configured to deflect in a radial direction.

An apparatus as above, wherein the coupler comprises a first end and an opposite second end, and wherein the lever is between the first end and the opposite second end.

An apparatus as above, wherein the adapter, coupler, and sleeve are configured to house an LC connector.

In another exemplary embodiment, an apparatus comprising: an adapter; a coupler configured to be connected to the adapter; and a sleeve connected to the coupler, wherein the sleeve comprises a ramp feature, and wherein a portion of the coupler is configured to deflect when the portion of the coupler is rotated over the ramp feature.

An apparatus as above, wherein the coupler comprises a lever, and wherein the lever is configured to deflect when the lever is rotated over the ramp feature.

An apparatus as above, wherein the coupler receives a first end of the sleeve.

An apparatus as above, wherein the ramp feature and the sleeve comprise a one-piece member.

An apparatus as above, wherein the sleeve comprises a general tubular shape.

An apparatus as above, wherein the sleeve comprises a first end and an opposite second end, and wherein the ramp feature is between the first end and the opposite second end.

An apparatus as above, wherein the coupler comprises a first end and an opposite second end, and wherein the ramp feature is between the first end and the opposite second end.

An apparatus as above, wherein the adapter, coupler, and sleeve are configured to house an LC connector.

In another exemplary embodiment, an apparatus comprising: an adapter; a coupler configured to be connected to the adapter; a sleeve connected to the coupler; and means for locking the coupler to the sleeve to prevent rotation of the coupler relative to the sleeve.

An apparatus as above, wherein the means for locking the coupler to the sleeve includes a lever feature of the coupler and a ramp feature of the sleeve.

If desired, the different functions discussed herein may be performed in a different order and/or concurrently with each other. Furthermore, if desired, one or more of the above-described functions may be optional or may be combined.

It should be understood that the foregoing description is only illustrative of the one or more various exemplary embodiments. Various alternatives and modifications can be devised by those skilled in the art without departing from the one or more various exemplary embodiments. Accordingly, the one or more various exemplary embodiments are intended to embrace all such alternatives, modifications and variances which fall within the scope of the appended claims.

1. An apparatus comprising:
an adapter;
a coupler configured to be connected to the adapter, wherein the coupler comprises a lever; and
a sleeve connected to the coupler;
wherein the lever is configured to deflect when the coupler is rotated relative to the sleeve.

2. An apparatus as claimed in claim 1, wherein the sleeve comprises a ramp feature, and wherein lever is configured to deflect when the lever is rotated over the ramp feature.

3. An apparatus as claimed in claim 1, wherein the lever extends from the coupler in a general cantilever fashion.

4. An apparatus as claimed in claim 1, wherein the lever and the coupler comprise a one-piece member.

5. An apparatus as claimed in claim 1, wherein the sleeve comprises a general tubular shape.

6. An apparatus as claimed in claim 1, wherein the lever is configured to deflect in a radial direction.

7. An apparatus as claimed in claim 1, wherein the coupler comprises a first end and an opposite second end, and wherein the lever is between the first end and the opposite second end.

8. An apparatus as claimed in claim 1, wherein the adapter, coupler, and sleeve are configured to house an LC connector.

9. An apparatus comprising:
an adapter;
a coupler configured to be connected to the adapter; and
a sleeve connected to the coupler, wherein the sleeve comprises a ramp feature, and wherein a portion of the coupler is configured to deflect when the portion of the coupler is rotated over the ramp feature.

10. An apparatus as claimed in claim 9, wherein the coupler comprises a lever, and wherein the lever is configured to deflect when the lever is rotated over the ramp feature.

11. An apparatus as claimed in claim 9, wherein the coupler receives a first end of the sleeve.

12. An apparatus as claimed in claim 1, wherein the ramp feature and the sleeve comprise a one-piece member.

13. An apparatus as claimed in claim 1, wherein the sleeve comprises a general tubular shape.

14. An apparatus as claimed in claim 1, wherein the sleeve comprises a first end and an opposite second end, and wherein the ramp feature is between the first end and the opposite second end.

15. An apparatus as claimed in claim 1, wherein the coupler comprises a first end and an opposite second end, and wherein the ramp feature is between the first end and the opposite second end.

16. An apparatus as claimed in claim 1, wherein the adapter, coupler, and sleeve are configured to house an LC connector.

17. An apparatus comprising:
an adapter;
a coupler configured to be connected to the adapter;
a sleeve connected to the coupler; and
means for locking the coupler to the sleeve to prevent rotation of the coupler relative to the sleeve.
